(19) United States
(12) Patent Application Publication
(10) Pub. No.: US 2008/0245674 A1
(43) Pub. Date: Oct. 9, 2008

(54) SYSTEM AND METHOD FOR OBTAINING ANISOTROPIC ETCHING OF PATTERNED SUBSTRATES

(76) Inventors: Robert J. von Gutfeld, New York, NY (US); Alan C. West, Tenafly, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/040,378

(22) Filed: Feb. 29, 2008

Related U.S. Application Data
(63) Continuation of application No. PCT/US06/64051, filed on Sep. 1, 2006.
(60) Provisional application No. 60/714,057, filed on Sep. 2, 2005.

(51) Int. Cl. B05D 5/04

(52) U.S. Cl. 205/640

(57) ABSTRACT

Systems and methods for etching topographic features in non-crystalline or metallic substrates are provided. A protective material is placed and patterned on a surface of the substrate to define exposed and protected regions of the substrate for etching in a liquid etchant having etching rates that are thermally activated. A nonuniform temperature profile is imposed on the substrate so that the temperatures and hence the etching rates at surfaces in the exposed regions are higher than those in the protected regions. Arrangements for imposing the nonuniform temperature profile include heating designated portions of the substrate with light radiation. Alternatively, the non-uniform temperature profile is developed as etching progresses by passing current pulses through the substrate in a manner that causes geometrically non-uniform heating of the substrate.

### CROSS-REFERENCE TO RELATED APPLICATIONS

This application claims the benefit of U.S. provisional application Ser. Nos. 60/714,057 filed Sep. 2, 2005, which is incorporated by reference herein in its entirety.

### FIELD OF THE INVENTION

The present invention relates to systems and methods for etching of patterns in substrates.

### BACKGROUND OF THE INVENTION

Micro-Electro-Mechanical Systems (MEMS) devices and other similarly sized electronic and electromechanical devices are made by using so-called microfabrication or micromachining processes to shape device materials or substrates. In the micromachining processes, the substrate surfaces are patterned (e.g., using a blocking photoresist as a stencil) and then exposed to chemicals that etch and remove material from exposed surface areas.

Conventional chemical and electrochemical etchants are usually isotropic in their action. The rate at which material is etched or removed by action of the chemical etchants is the same in all directions. When such chemical etchants are used to etch patterned substrates, the result is undercutting, i.e., removal of material under the patterned or blocked surface areas. The etched region or volume extends not only in the downward direction away from the photoresist pattern, but also sideways under the photoresist pattern. A desired shape for an etched volume may be a rectangular hole or a slot with vertical sidewalls as defined by a photoresist pattern. However, with etching occurring in a sideways direction undercutting the photoresist pattern, the resulting etched volume will extend underneath the photoresist pattern. (See e.g., FIG. 4). The sidewalls of the etched volume may curve inward in a somewhat concave manner. Therefore, the cross-sectional area of the etched volume is larger at the bottom than at the top defined by the photoresist pattern. The undercutting caused by isotropic etching is generally difficult to control.

Therefore, successful prior art microfabrication processes (e.g., for making inkjet printer nozzles), which have stringent dimensional tolerances, use anisotropic chemical etchants instead of isotropic chemical etchants. The crystalline structure of the device substrate itself may be exploited to obtain anisotropic etching using specific chemical etchant chemistries. Several specific anisotropic etchant chemistries are available for crystalline silicon material. Accordingly, inkjet printer nozzles and other MEMS device structures use crystalline silicon as the substrate material. Anisotropic etchant chemistries also have been developed for a few additional crystalline substrate materials.

Etching processes also are frequently used in the semiconductor device or circuit fabrication. The substrates used for semiconductor device or circuit fabrication are generally planar and etching patterns on them are defined by photolithographic means. One of the most common materials requiring etching in the semiconductor industry is copper, which may be initially deposited as a blanket overlayer or sheet on a circuit board or on top of several other deposition layers on a semiconductor device chip. In some instances, a copper sheet may be laminated onto a board. The copper overlayer or sheet is subsequently patterned by photolithographic means prior to etching. Select portions of the patterned copper are then removed by etching to form discrete copper lines for conducting signals between circuit or device elements. For such applications (i.e., etching narrow conductor lines), it is desirable to inhibit isotropic etching of the substrate material, which leads to lack of control over the dimensions of the desired conductor lines. Isotropic etching causes undercutting due to sideways or horizontally directed etching of the lithographically protected portions of the copper that are not intended to be etched. The resulting isotropically etched regions have a concave geometry whereas vertical sidewall geometries are preferable. The undercutting of the copper lines also weakens the etched structure.

Consideration is now being given to improving etching processes for etching patterned substrates with a view to avoid or minimize undercutting so that etched regions with vertical (or nearly vertical) sidewalls can be obtained. Attention is directed, in particular, to etching processes based on conventional or otherwise convenient chemical etchant formulations. Attention is also directed to etching processes that may be used for shaping non-crystalline substrate materials such as metals.

### SUMMARY OF THE INVENTION

Systems and methods are provided for directional etching of patterned substrates including those made of non-crystalline materials. The systems and methods use common chemical or electrochemical etchants whose etching behaviors or reactions are thermally activated.

A method for directional etching a substrate includes patterning protective materials on the surface of the substrate to define exposed and protected regions of the substrate for etching. The patterned substrate is placed in a liquid etchant having thermally activated etching rates. A nonuniform temperature profile is imposed on the substrate so that the temperatures at etching surfaces in the exposed regions are higher than those at etching surfaces in the protected regions. Thus, the substrate is etched at a faster rate in the exposed regions than in the protected regions.

The nonuniform temperature profile may be obtained by radiation heating or by joule heating, which is non-uniformly applied.

A system for etching a substrate, which may be patterned using protective coatings, includes an arrangement for imposing a non-uniform temperature profile on the etching surfaces of the substrate immersed in an etching solution. The non-uniform temperature profile can be designed so that the temperature at etching surfaces in the exposed regions of the substrate are at higher temperatures than those at the etching surfaces in the protected regions of the substrate. Thus, higher etching rates can be obtained at the former etching surfaces compared to the etching rates at the latter etching surfaces.

The arrangement for imposing the nonuniform temperature profile may include a suitable light source or other radiation source for irradiating the substrate. Alternatively or additionally, the arrangement may include a current source that is connected across the ends of the substrate to cause electrical current to flow through the substrate during etching.

### BRIEF DESCRIPTION OF THE DRAWINGS

Further features of the disclosed etching systems and methods will be more apparent from the following detailed description and the accompanying drawings, wherein like reference characters represent like elements throughout, and in which:

FIG. 1 is a schematic illustration of an exemplary etching arrangement for directional etching and shaping a metallized substrate, in accordance with the principles of the present invention. The metallized substrate may be an electronic circuit board with a copper overlayer on which a photoresist coating defines an etching pattern.

FIG. 2a is a schematic illustration of a temperature-dependent anisotropic etching process in which the substrate is heated using light pulses, in accordance with the principles of the present invention. FIG. 2a shows an enlarged view of a portion of the circuit board substrate of FIG. 1, which is heated by light pulses generated by the giant flash lamp.

FIG. 2b is a schematic illustration of a copper overlayer trench having vertical sidewalls, which is etched in the circuit board substrate of FIG. 1 using light pulse heating, in accordance with the principles of the present invention. FIG. 2b shows an enlarged view of a portion of the circuit board substrate of FIG. 2a.

FIG. 3a is a schematic illustration of an exemplary temperature-dependent anisotropic etching system and process in which the substrate is anisotropically heated using electrical pulses, in accordance with the principles of the present invention.

FIG. 3b is a schematic illustration of the details of the electrical contacts made to the substrate in the etching system of FIG. 3a for flowing electrical current pulses through copper portions of the substrate, in accordance with the principles of the present invention.

FIG. 3c is a schematic illustration of a sequence of electrical pulses designed to heat the substrate undergoing etching (FIG. 3b) in a manner which minimizes etching in the lateral direction, in accordance with the principles of the present invention. The sequence of electrical pulses includes pulses of alternating polarity.

FIG. 4 A is a schematic illustration of prior art etching processes in which isotropic etching rates result in concave sidewalls and undercutting of patterned substrates.

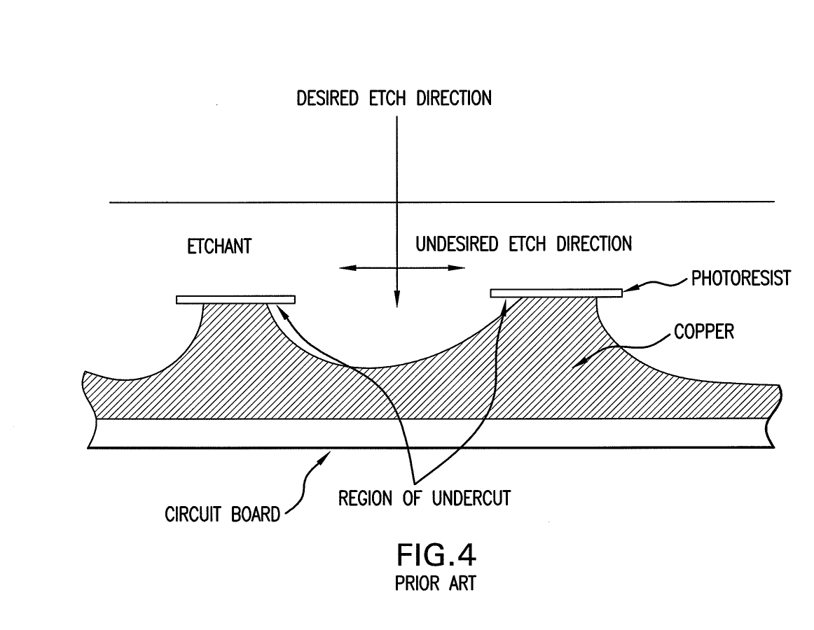

### DETAILED DESCRIPTION

Systems and methods for directional etching of topographic features in patterned substrates are provided. Etchants whose reactions are thermally activated are used. Directional etching processes are designed to reduce or avoid undercutting of the etched topographic features by thermally enhancing vertical etch rates over lateral etch rates. The systems and methods exploit the temperature dependence of etching reactions to enable etching of anisotropic features with sidewalls that are substantially vertical. The vertical etch rates are enhanced by imposing a non-uniform temperature pattern on the substrate surface. The non-uniform temperature pattern is achieved by heating designated substrate portions with intense short pulses of optical radiation. Alternatively, the non-uniform temperature pattern is developed as etching progresses by passing current pulses through the substrate in a manner that causes geometrically non-uniform heating of the substrate.

The etched substrates, for example, with vertical sidewalls, may be used as electronic or electromechanical device structures. The etching systems and methods may be used to anisotropically etch substrates that have a crystalline structure and/or substrates that have a non-crystalline structure.

For substrates that have an isotropic crystalline structure, it is well known that chemical etching or electro-etching using common etchants proceeds isotropically. The rate of etching on any surface exposed to an etchant is generally the same in all directions. Similar etch rates in the vertical and sideways directions cause undesirable undercutting of the etched structures. The inventive etching systems and methods can substantially reduce undesirable undercutting by making the etching processes directional or anisotropic.

In the inventive systems and methods, etchants whose reaction is thermally activated are utilized for etching the substrates. The etch rate R of a suitable etchant may, for example, be related to temperature by the Arrhenius function:

R=A exp−ΔE/kT (1)

where A is a constant, k is Boltzmann's constant, T is the absolute temperature, and ΔE is the activation energy required for the etching reaction to proceed. The inventive systems and methods exploit the temperature dependence of the etching rate to obtain anisotropic electrochemical etching of metallic or conducting substrates. The same principle is also used to chemically etch non-conducting or insulating substrates.

An exemplary substrate may be an insulating board that has a metal layer affixed on one of its surfaces. The metal layer may require etching in order to form a desired metal pattern. Another exemplary substrate may be a freestanding metal sheet or strip that requires etching in order to form a desired metal pattern. For thermally activated etching, heat is applied to the metallized surface of the subject substrate in a suitable non-uniform geometrical pattern. The non-uniform heating imposes a non-uniform temperature profile on the subject substrate. The non-uniform temperature profile selectively activates etching reactions on the surface of the substrate. The non-uniform temperature profile is designed to minimize sideways etching and to maximize vertical etching in desired surface regions or substrate portions.

Directionality or anisotropy of etching is achieved by encouraging a higher vertical etch rate compared to the sidewise etch rate. The directionality or anisotropy of etching may be forced by anisotropic or non-uniform heating of the substrate. In exemplary implementations of the systems and methods, the subject substrate is heated in a non-uniform manner or pattern, which leads to higher temperatures at planar substrate surfaces than at vertical substrate surfaces. Accordingly, the rate of etching at planar substrate surfaces is higher than that at vertical surfaces that are at lower temperatures. The relative rates of etching at the two surfaces can be suitably controlled or adjusted to yield etch features with vertical sidewalls.

Incident light or radiation pulses may be used to heat the surface of a subject substrate, which may be patterned using suitable photoresist material. Alternatively or additionally, the surface may be heated using joule heating induced by passing electrical current pulses through the substrate. In both heating techniques, the applied pulses may be temporally and spatially localized to preferentially heat the patterned substrate regions or portions that are designated for etching, and to avoid heating sidewall portions and other portions that are protected by the photoresist material and are not designated for etching.

The inventive etching systems and methods in which anisotropic etching rates are obtained by anisotropic heating as described above may be used to etch any patterned metal layer deposited or affixed on a substrate. The substrate is preferably made from material that is electrically insulating or is weakly conducting in comparison to the conductivity of the metal layer to be etched. While the substrate to be etched is submerged in an etchant, a heat pulse is applied to the substrate by either an intense light pulse or an electrical pulse.

For light pulse heating, the wavelength of light may be suitably selected so that most of the incident light is absorbed by the illuminated substrate regions. Correspondingly, the photoresist material used for patterning the substrate may be chosen to reflect most of the incident light pulses, which may be intense.

Light pulses suitable for the anisotropic heating of the substrate may have pulse widths about a few ns or μs, and optical power densities about 10¹-10⁸ W/cm². The light pulses may be generated by a light source, which is a pulsing stationary source or a source attached to a scanning system. A stationary light source can be a pulsed flashlamp (e.g., a pulsed xenon flashlamp) or a pulsed laser. The light source may be configured so that the incident light pulses can be scanned over the substrate with a high repetition rate or frequency, for example, in the range 10 Hz to 100 kHz. The light source may be operated in a cw mode, if the light source can be rapidly scanned over the substrate. A scanning mode of operation may be especially useful in combination with a focused laser light source. The light source attached to a scanning system may, for example, be cw laser, which is raster scanned across the surface of the subject substrate. The laser may be focused or unfocused depending on the rate of scanning and other process parameters. Suitable raster scanning routines, which are equivalent to pulsing light from a stationary source, may be used to heat various portions of the substrate surface for short durations of time.

The metal surface of the substrate to be etched may be patterned using photoresist material, which is highly reflective to the incident light. Exposed portions of the substrate, which are not covered with photoresist material, will absorb greater amounts of light and will correspondingly be heated to higher temperatures than the photoresist covered portions that reflect the incident light pulses. The non-uniform or anisotropic heating of the substrate portions leads to a corresponding anisotropy in the etching rates. However, when electrical current pulses are used for the anisotropic heating of the substrate, the patterning material need not be reflective to light. In this case, the patterning material or photoresist acts merely as a blocking stencil or mask to define the metal regions etched at the beginning of the etching process. Such photoresist may not have any significant influence on the development of the temperature-based anisotropic etch rates in the etching process.

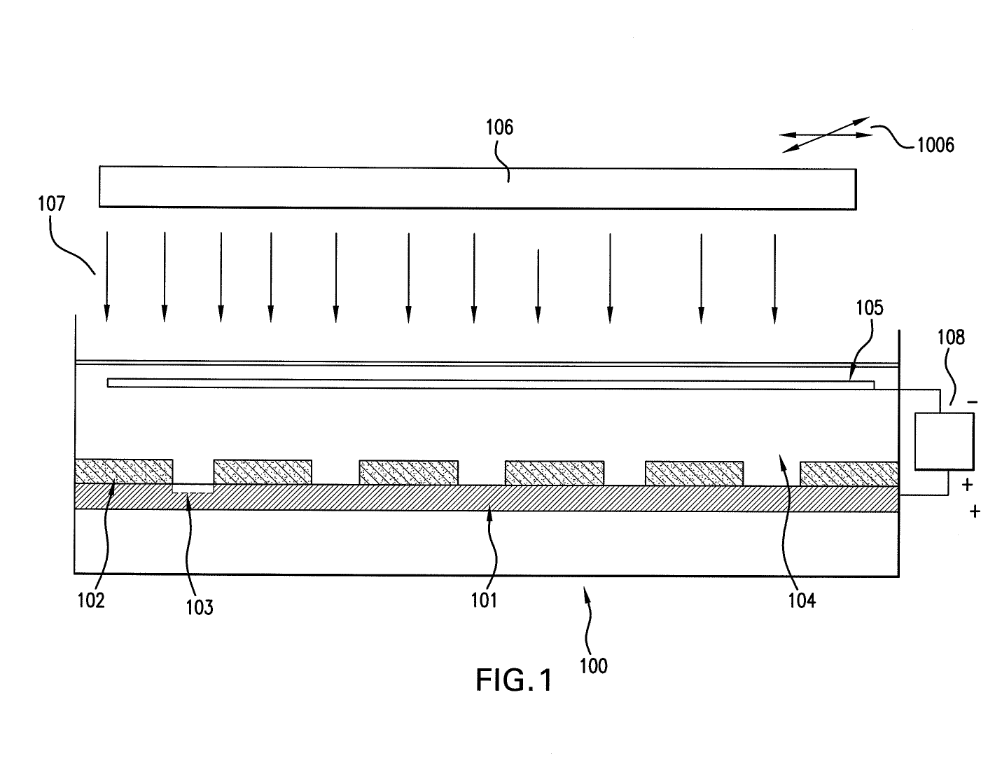

FIG. 1 shows an exemplary etching system in which non-uniform or anisotropic heating of the surface layer of substrate 100 is used to promote directional or anisotropic etching. Substrate 100 may, for example, be an electronic circuit board on which a blanket or surface layer of copper 101 has been deposited or otherwise affixed. Copper layer 101 is coated with a photoresist layer 102, which is lithographically patterned to define the etch regions and the desired final conductor lines. For removing the etch regions, subject substrate 100 is submerged in a liquid etchant 104 in an etch tank. Liquid etchant 104 may be an ordinary liquid etchant (i.e., non-electrolytic etchant) or an electrolytic etchant. In the latter case, copper layer 101 can be utilized as the working electrode. An electrically conducting counter-electrode 105 is also immersed in the etch tank. A voltage supply 108, which can be operated continuous wave (cw) mode or in a pulsed mode, is placed across the two electrodes for controlling electrolytic action. For chemical etching as opposed to electrochemical etching (i.e. electroetching), counter electrode 105 and voltage source are not used.

A light source (e.g., a pulsed giant scanning flash lamp 106) provides light radiation 107 for heating substrate 100 in a non-uniform manner during the etching processes. The light source may be any suitable radiation source, which can emit short and intense light pulses (e.g., pulses about a few microseconds in duration). Substrate 100 is submerged in liquid etchant 104 with its top surface exposed to optical pulses generated by giant flash lamp 106. The optical pulses, which are absorbed primarily in exposed surface regions not covered by the photoresist, heat substrate 100 in a non-uniform manner leading to the anisotropic etching of the copper overlayer.

In alternative etching arrangements, it may be possible to use a light source such as a pulsed laser or an array of laser diodes in place of scanning flash lamp 106. The light source may be configured as a computer-controlled scanning arrangement so that the incident light radiation can be scanned over the entire surface of substrate 100. If the scanning of the light source is sufficiently rapid, the light source need not be pulsed but can be a continuous (cw) source.

In etching systems where the etchant is an electrolytic etchant, it may be necessary to interpose a transparent counter electrode facing the metal layer in the path of the incident light pulses (e.g., FIG. 1 counter electrode 105). The transparent counter electrode may be made of glass with a coating of indium tin oxide or other suitable materials, which are known to be conductive and transparent in the visible spectrum. Very little, if any, attenuation of the incident light used to heat the substrate will occur with proper design of the indium tin oxide coating. Other counter-electrode structures (e.g., a mesh) that allow light to pass through may be used instead of the glass counter electrode.

In an etching process based on optical heating, while substrate 100, copper layer 101 and photoresist 102 are immersed in liquid etchant 104, a suitable voltage potential may be applied between copper layer 101 and electrode 105 using voltage supply 108 to initiate electrolytic or electrochemical etching reactions at the surface of metal layer 101. Scanning flash lamp 106 emits pulsed radiation 107 onto exposed portions of metal layer 101 and photoresist 102. Portions of radiation 107 that are incident on surface portions of metal layer 101 covered with photoresist 102 are reflected by the photoresist. Conversely, portions of radiation 107 that are incident on uncovered or exposed surface portions is absorbed into metal layer 101. Accordingly, incident radiation 107 causes a greater degree of heating on the horizontal surfaces of metal layer 101 at the bottom of etched region 103 that are not protected by the reflecting photoresist 102 than on vertical side wall surfaces of etched region 103 that are protected from heating by photoresist 102. The etching rates of the two surfaces are related to the local surface temperatures. (See Eq. 1). The vertical sidewalls, which are cooler, etch more slowly than the horizontal surfaces, which are hotter. In other words, the vertical etch rate is enhanced over the horizontal or sideways etch rate. The degree of enhancement is a function of the light output intensity per pulse and the repetition rate of the flash lamp 106, and the relative increase in local surface temperatures on copper layer 101. This etching process based on optical heating also can be used to obtain anisotropic chemical etching of an electrically insulating substrate.

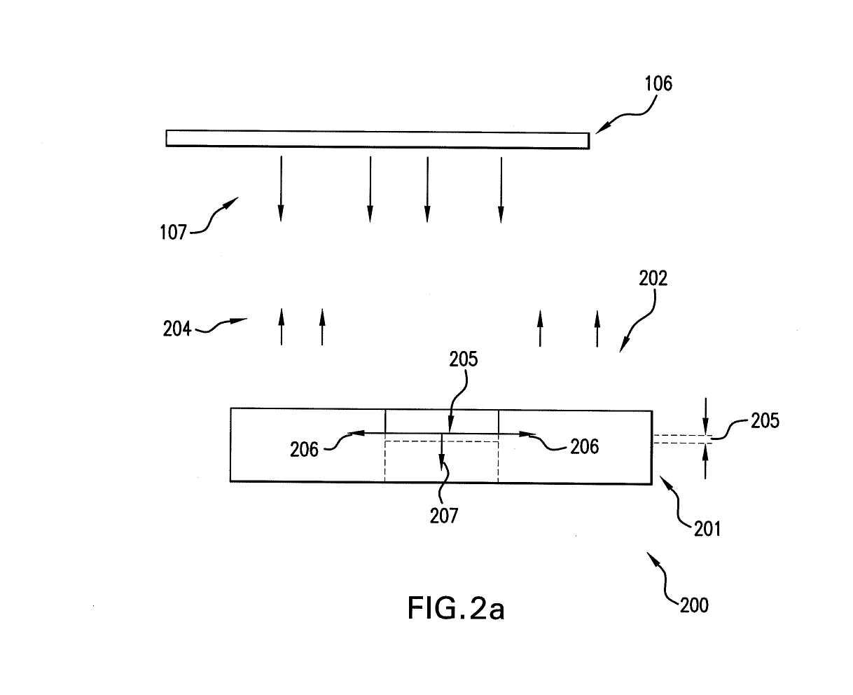

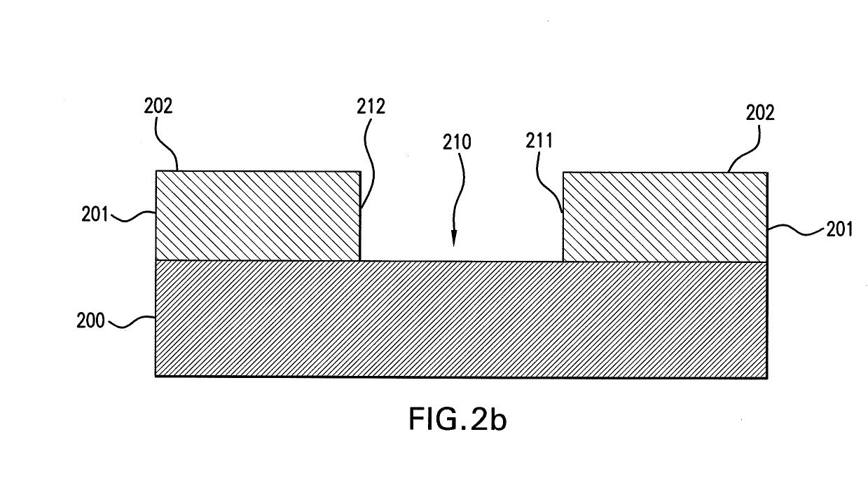

FIG. 2a shows further details of the anisotropic etching processes stimulated or activated using a high intensity lamp or other intense light source such as a laser. FIG. 2a shows the relative changes in temperature in different portions of copper layer 201 in a section 200 of substrate 100 that are caused by the anisotropic absorption of a single pulse of optical radiation. Copper layer 201 is patterned by photoresist coating 202. The photoresist material for the coating is selected to be considerably more reflective to the incident light wavelength from lamp 106 than is metal layer 201. In FIG. 2a, incident light pulses 107 are represented by arrows directed downward to substrate 200 and light reflection from the surface of photoresist 204 is represented by arrows 204 directed upward from substrate 200. Further, the amounts of light absorption and heating in the various copper portions of substrate 100 are represented by arrows 206 and 207 of varying widths in the respective copper portions.

Incident light 107 is absorbed into the exposed portions of copper layer 201 over an absorption length 205. In FIG. 2a, arrows 206 and 207 also represent the changes in temperature due to the absorption of light pulses 107. The width of arrows 206 and 207 as shown is a measure of the temperature change. The heavier or wider arrow 207 represents a higher temperature in the vertical direction compared to the sidewall temperature, which is represented by the narrower or thinner arrows 206. The value of this temperature difference or anisotropy may depend on thermo physical properties of the metal and the photoresist, the intensity and duration of the light pulse, and on the optical absorptive and thermal properties of the etchant 104. In addition, the degree of agitation of liquid etchant 104 also may affect the value of the temperature difference. The directional temperature difference or anisotropy may be computed theoretically for a given incident light pulse or heat source.

In an ideal anisotropic etching scenario, the vertical sidewalls of etched region 103 will remain vertical and the bottom layer of the etched region will remain in a horizontal plane as etching progresses through copper layer 201. FIG. 2b shows the results that may be obtained in the ideal anisotropic etching scenario. After copper layer 201 is fully etched to form desired conductor lines 201 protected by photoresist 202, etched volume 210 has vertical sidewalls 211 and 212. It is understood that while the ideal anisotropic etching scenario may not be fully attainable in practice, the inventive etching Systems and methods are expected to improve the verticality of the sidewalls over that obtained using prior art etching techniques.

In an etching process based on joule heating, electrical current pulses can be applied directly to opposite ends of the substrate. This will result in anisotropic heating due to joule heating caused by current dissipation. Typical pulse durations of the current pulses may be in the range of 1 ns to 100 ms with a repetition rate of from 1 to 106 pulses per second and current densities ranging from 1-500 Amperes/pulse. The voltage source, which generates the electrical current pulses, is operated in pulsed mode in order to achieve the desired thermal anisotropy and hence, etching anisotropy. The voltage source may be a source configured to generate pulses of alternating polarity. The distribution of joule heat is such that the portions of the substrate designated for etching have a greater temperature rise than the patterned portions of the substrate that should not be etched. The photoresist pattern materials protect the latter portions from initial etching which defines the etching volumes. The thermal anisotropy resulting from the non-uniform joule heating leads to a higher etch rate in the portions designated for etching in a direction perpendicular to the substrate plane. The anisotropic heating reduces the lateral etching which causes undercutting.

In instances where the etchant is an electrolytic etchant, a second voltage source may be used to apply a pulsed electrolytic potential between the substrate and a counter electrode. The timing between the electrolytic potential pulses and the electrical current pulses for joule heating may be conveniently selected so that there is no overlap between the two types of pulses. For chemical anisotropic etching, a counter electrode and a voltage source between the electrode and the counter electrode are not necessary as part of the etching system. However, both sources of anisotropic heating, i.e. optical pulses or electric current through the metal layer are used. The combination of both heating sources can also be used for both chemical and electrochemical anisotropic etching.

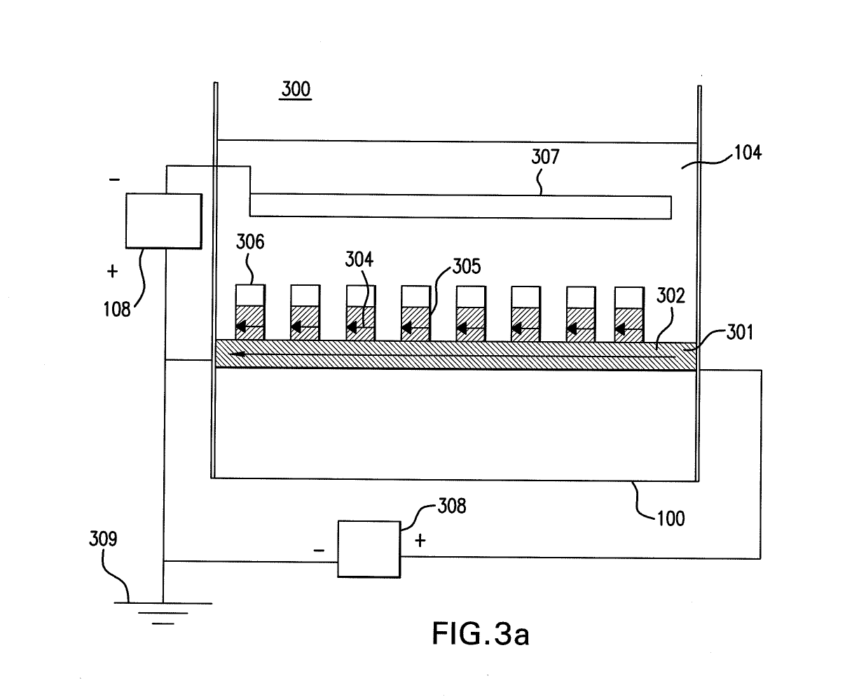

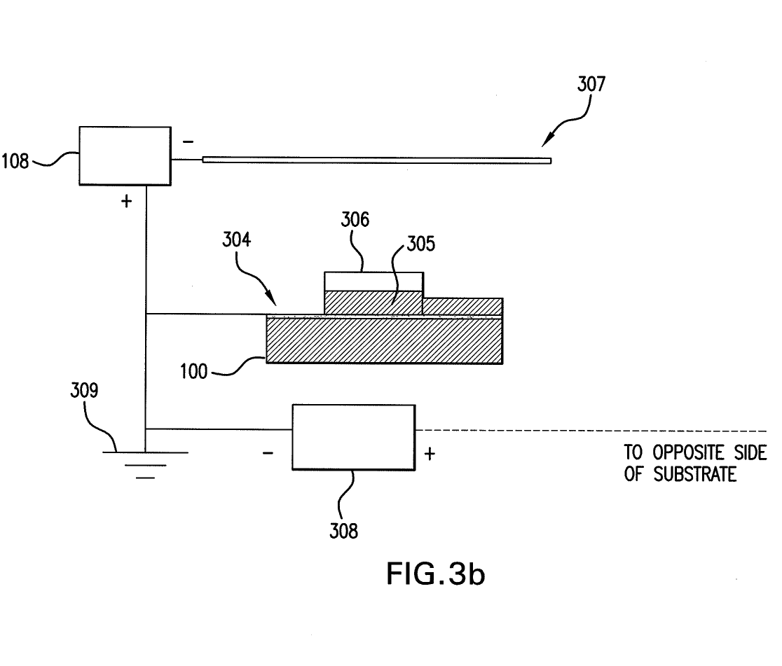

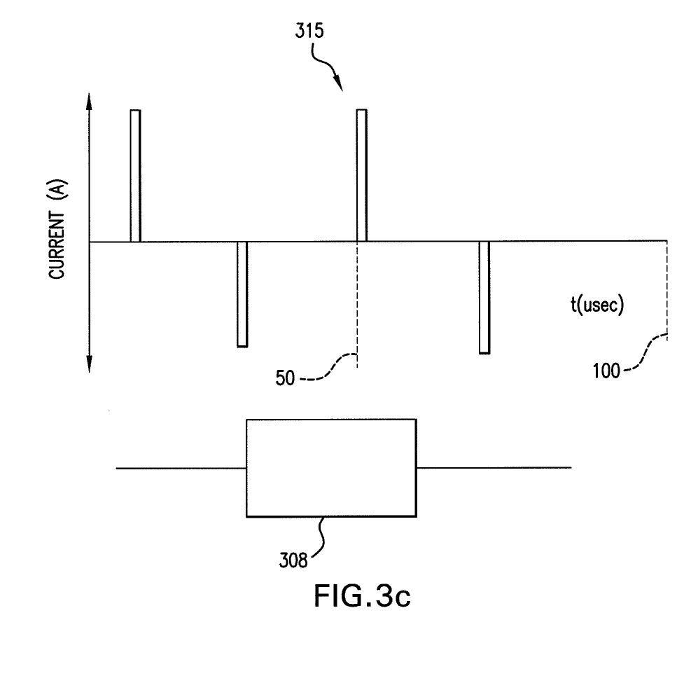

FIG. 3a shows an exemplary etching system 300 in which a non-uniform or anisotropic joule heating processes are used to promote directional or anisotropic pattern etching. In system 300, substrate 100 is placed in etchant 104 in an etch tank in a manner similar to that shown in FIG. 1. A counter-electrode 307 may also be immersed in the etch tank. In system 300, joule heating of circuit board substrate 100 is obtained by flowing current pulses through metal layer 301, which may be copper or any other metal such as aluminum, gold, silver, tantalum, and titanium. A voltage or current source 308, which may be a pulsed source, is utilized to flow current through metal layer 301. Further, a voltage supply 108 may be connected to counter-electrode 307 and metal layer 301, which acts as a working electrode, for initiating electrolytic etching reactions in instances where etchant 104 is an electrolyte. Voltage supply 108 and source 308 may be commonly grounded (e.g., at ground 309).

FIG. 3b, which is an enlarged side view of a section of FIG. 3a, shows details of an exemplary configuration of electrical connections between voltage source 108, voltage supply 308, counter-electrode 307, and copper layer 301 on substrate 100. In the configuration shown, one end of copper layer 301 on substrate 100 is connected to the positive polarity terminal of voltage source 108. Conversely, the other end of copper layer 301 is connected to the positive polarity terminal of voltage source 308. The positive polarity terminal of voltage source 108 and the negative polarity terminal of voltage source 308 are commonly grounded (309). Further, the negative polarity terminal of voltage source 108 is connected to counter-electrode 307. In other suitable configurations, the polarities of the voltage source 308 connections may be reversed.

During the etching of layer 301 which is affixed to the circuit board substrate 100, voltage source 308 may be operated (i.e., pulsed) independently of the operation of voltage source 108, which is designed to provide a potential difference between counter-electrode 307 and metal layer 301 for electrochemical etching processes. It will be understood that counter electrode 307 and voltage source 108 are not needed or used for anisotropic chemical etching processes.

With renewed reference to FIG. 3a, the figure shows a process stage at which the initial copper layer 301 on substrate 100 has already been partially etched. Photoresist 306 covers non-etched metal portions 305, which are an integral part of continuous metal layer 301 but which are purposely protected from etching by pre-patterned photoresist 306. Layer 301 is therefore patterned by way of anisotropic etching of layer 301. Layer 301 is thinned in designated places prescribed by the photoresist pattern with removal of material from layer 301. The etched volume is indicated by numeral 310.

Voltage source 308, which is connected across layer 301, is utilized to flow short pulses of current through copper layer 301. The pulses of current may, for example, be in the range of 10 ns to 500 ms. The pulses of current flow principally through the continuous copper layer 301 with very little current flowing through abutting portions 305. In FIG. 3a, the current flows in the metal layer are represented by arrows 302 and 304. Wide arrow 302 represent the major flow of current in thinning copper layer 301, while narrow arrows 304 represent the smaller currents that may flow through non-etched metal portions 305. This disparity in current flows causes more joule heating and accompanying temperature rise at the exposed surfaces of layer 301 than at the surfaces of non-etched metal portions 305. Thus, the exposed horizontal surfaces of layer 301 will etch faster during a heating cycle than will the vertical sidewalls of portions 305.

It will be noted that the thermal conductivity of the interface between metal layer 301 and liquid etchant 104 may be relatively poor compared to the thermal conductivity of the interface between metal layer 301 and non-etched metal portions 305. In practice, as current is pulsed through metal layer 301, the noted thermal properties of the two interfaces will cause regions of metal layer 301 that are between portions 305 to periodically become hotter than portions 305. This temperature phenomenon is expected to additionally enhance etching of the exposed planar surface of layer 301 in comparison to the etching of the sidewalls of portions 305. (See e.g., Eq. 1.)

It will also be noted that when pulses from voltage supply 308 are applied to metal layer 301, there may be a small lateral voltage drop in the metal layer along the length of substrate 100. This lateral voltage drop, if sufficiently large, may cause laterally non-uniform etching along the length of substrate 100. Such lateral non-uniformity in etching can be avoided or averaged out in time by flowing current pulses of alternating polarity through metal layer 301 for joule heating. For such applications, voltage source 308 may be a pulse generator that is configured to generate a sequence of alternating polarity current pulses. FIG. 3c shows an exemplary sequence of alternating polarity pulses generated by voltage source 308. Any lateral anisotropy in voltage across the metal layer is smoothed out in time with equally small voltage drops in the opposite lateral direction.

It will be understood that the foregoing is only illustrative of the principles of the invention, and that various modifications can be made by those skilled in the art without departing from the scope and spirit of the invention. For example, some or all of the features of the different embodiments discussed above may be combined into a single embodiment. Conversely, some of the features of a single embodiment discussed above may be deleted from the embodiment.

We claim:

1. A method for etching a substrate, wherein a protective material is placed and patterned on a surface of the substrate to define exposed and protected regions of the substrate for etching, the method comprising:
placing the patterned substrate in a liquid etchant having etching rates that are thermally activated; and
imposing a nonuniform temperature profile on the substrate so that the temperatures at etching surfaces in the exposed regions of the substrate are higher than those at etching surfaces in the protected regions of the substrate,
whereby the substrate is etched at a faster rate in the exposed regions than in the protected regions.

2. The method of claim 1, wherein imposing the non-uniform temperature profile comprises heating the substrate in a non-uniform pattern.

3. The method of claim 1, wherein imposing the non-uniform temperature profile comprises irradiating the substrate with light.

4. The method of claim 3, wherein irradiating the substrate with light comprises irradiating the substrate with light pulses generated by a light source.

5. The method of claim 3, wherein irradiating the substrate with light comprises scanning light across the surface of the substrate.

6. The method of claim 3, wherein the protective material is reflective such that light incident on the protected regions of the substrate is substantially reflected

7. The method of claim 3, wherein the liquid etchant is an electrolytic etchant and wherein the light is generated by a light source, the method further comprising immersing a transparent counter electrode in the liquid etchant and disposing the transparent counter electrode between the light source and the substrate.

8. The method of claim 1, wherein imposing the non-uniform temperature profile comprises flowing electrical current through an electrically conducting surface layer of the substrate as the layer is being etched.

9. The method of claim 8, wherein flowing electrical current comprises flowing current pulses.

10. The method of claim 8 wherein the electrical current comprises current pulses of alternating polarity.

11. A system for etching a substrate on whose surface a protective material is placed and patterned to define exposed and protected regions of the substrate for etching, the system comprising:
an arrangement for imposing a non-uniform temperature profile on the etching surfaces of the substrate so that the temperature at etching surfaces in the exposed regions of the substrate are at higher temperatures than those at the etching surfaces in the protected regions of the substrate,
whereby the substrate can be etched at a faster rate in the exposed regions than in the protected regions by a liquid etchant having etching rates that are thermally activated.

12. The system of claim 11, wherein the arrangement for imposing a nonuniform temperature profile on the etching surfaces of the substrate comprises a light source configured to irradiate the substrate.

13. The system of claim 12 wherein the light source is configured to generate light pulses.

14. The system of claim 13 wherein the light pulses have durations in the range of about a few nanoseconds to about a few microseconds and intensities in the range of about 10²-10⁶ W/cm².

15. The system of claim 12 wherein the light source is configured to scan the substrate with incident radiation.

16. The system of claim 12 wherein the liquid etchant is an electrolytic etchant, the system further comprising a transparent counter electrode that is immersed in the liquid etchant and interposed between the light source and the substrate.

17. The system of claim 11, wherein the arrangement for imposing a nonuniform temperature profile on the etching surfaces of the substrate comprises a current source that is connected across the ends of the substrate to cause electrical current to flow through the substrate during etching.

18. The system of claim 17, wherein the current source is configured to flow current pulses through the substrate layer.

19. The system of claim 18 wherein the current pulses have a duration in the range of about 1 ns to 100 ms and a repetition rate of about 1 to 106 pulses per second.

20. The system of claim 18 wherein the current pulses are in the range of about 1-500 amperes.

21. The system of claim 18 wherein the current source is configured to flow current pulses of alternating polarity through the substrate layer.

22. The system of claim 11 wherein the etchant is an electrolytic etchant, the system further comprising a counter electrode and a voltage source for applying an electrolytic potential between the counter electrode and the substrate.

23. The system of claim 11, wherein the liquid etchant acts chemically on the etching surfaces.

24. The system of claim 11 wherein the etching surfaces comprise an electrically non-conducting surface.

25. The system of claim 11 wherein the arrangement for imposing a non uniform temperature profile on the etching surfaces of the substrate comprises:
a light source configured to irradiate the substrate surfaces with light; and
a current source that is connected across the ends of the substrate to flow electrical current through the substrate during etching.
